(19) United States
(12) Patent Application Publication
(10) Pub. No.: US 2026/0066829 A1
(43) Pub. Date: Mar. 5, 2026

(54) MOTOR DRIVER

(71) Applicant: Mitsubishi Electric Corporation, Chiyoda-ku, Tokyo (JP)

(72) Inventors: Kenta KANEKO, Tokyo (JP); Moriyuki HAZEYAMA, Tokyo (JP); Yu HAMADA, Tokyo (JP); Kota TERAMOTO, Tokyo (JP)

(73) Assignee: Mitsubishi Electric Corporation, Chiyoda-ku, Tokyo (JP)

(21) Appl. No.: 19/105,178

(22) PCT Filed: Sep. 7, 2022
(86) PCT No.: PCT/JP2022/033539

§ 371 Date: Feb. 20, 2025

(51) Int. Cl. H02P 27/08; H02K 1/24; H02P 23/30; H02P 25/098

(52) U.S. Cl. CPC H02P 27/085; H02K 1/24; H02P 23/30; H02P 25/098; H02K 2213/03

(57) ABSTRACT

A motor driver includes an inverter that converts a DC voltage into an AC voltage and applies the AC voltage to an AC motor, a DC voltage detector that detects the DC voltage applied to the inverter, a voltage command generator that generates a voltage command based on a torque command and a detection value of the DC voltage, and a gate signal generator that generates a gate signal for performing pulse width modulation control of the inverter. The number of slots per magnetic pole in the stator core of the AC motor is a natural number multiple of three, and there is a relationship of Fc=6n+3 between Fc and n, where Fc represents a numerical value as a carrier order obtained by normalizing the frequency of the carrier wave with the frequency of the modulated wave, and n is natural number.

### FIELD

The present disclosure relates to a motor driver adapted to drive an AC motor having a plurality of slots arranged at equal intervals along an inner circumferential surface of a stator core.

### BACKGROUND

It is known that torque ripple that depends on the number of slots is generated in an AC motor having a plurality of slots in a stator core. Since this type of torque ripple is generated due to the structure of the AC motor, design for reducing the torque ripple by devising the structure of the AC motor is often performed.

Meanwhile, it is known that torque ripple is also generated by harmonics that occur through pulse width modulation (PWM) control of an inverter that drives an AC motor. In Patent Literature 1 below, in order to reduce this type of torque ripple, the motor current is detected in a cycle longer than the switching cycle of the inverter, the motor current in a period in which the motor current is not detected is estimated, and the PWM pulse to the inverter is calculated such that the estimated motor current value matches the current command value.

### Citation List

### Patent Literature

Patent Literature 1: Japanese U.S. Pat. No. 6,407,683

### SUMMARY OF INVENTION

### Problem to be Solved by the Invention

However, the calculation processing of Patent Literature 1 is complicated, and there is a problem that the processing time and the processing load required for the calculation increase.

The present disclosure has been made in view of the above, and an object thereof is to provide a motor driver capable of reducing torque ripple while suppressing an increase in processing time and processing load.

### Means to Solve the Problem

In order to solve the above-described problems and achieve the object, a motor driver according to the present disclosure is a motor driver adapted to drive an AC motor having a stator core in which a plurality of slots arranged at equal intervals along an inner circumferential surface are formed, and includes an inverter, a DC voltage detector, a voltage command generator, and a gate signal generator. The inverter is adapted to convert a DC voltage into an AC voltage and to apply the AC voltage to the AC motor. The DC voltage detector is adapted to detect a DC voltage applied to the inverter. The voltage command generator is adapted to generate a voltage command based on a torque command and a detection value of the DC voltage. The gate signal generator is adapted to generate a gate signal for performing pulse width modulation control of the inverter based on a comparison result between a modulated wave that is a waveform of a voltage command and a carrier wave. The number of slots per magnetic pole in the stator core is a natural number multiple of three. There is a relationship of Fc=6n+3 between Fc and n, where Fc represents a numerical value as a carrier order obtained by normalizing the frequency of the carrier wave with the frequency of the modulated wave, and n is natural number.

### Effects of the Invention

The motor driver according to the present disclosure achieves the effect of reducing torque ripple while suppressing an increase in processing time and processing load.

### BRIEF DESCRIPTION OF DRAWINGS

FIG. 1 is a diagram illustrating a configuration of a motor driver according to an embodiment.

FIG. 2 is a diagram illustrating an example of the waveform of one phase of a modulated wave generated by the modulated wave generator of FIG. 1 and the waveform of a carrier wave generated by the carrier wave generator of FIG. 1.

FIG. 3 is a cross-sectional view of the AC motor according to the embodiment taken along the axial direction of a shaft.

FIG. 4 is a cross-sectional view of the AC motor illustrated in FIG. 3 taken along line A-A in FIG. 3.

FIG. 5 is a cross-sectional view illustrating one magnetic pole of the 6-pole 36-slot reluctance motor illustrated in FIG. 4.

FIG. 6 is a waveform diagram illustrating torque fluctuation at the time when the 6-pole 36-slot reluctance motor illustrated in FIG. 4 is driven with the carrier order 27.

FIG. 7 is a diagram illustrating a frequency analysis result of the torque fluctuation waveform illustrated in FIG. 6.

FIG. 8 is a diagram illustrating a frequency analysis result of a torque fluctuation waveform at the time when the 6-pole 36-slot reluctance motor illustrated in FIG. 4 is driven with the carrier order 17.

FIG. 9 is a diagram illustrating a frequency analysis result of a torque fluctuation waveform at the time when the 6-pole 36-slot reluctance motor illustrated in FIG. 4 is driven with the carrier order 15.

FIG. 10 is a diagram illustrating a relationship between the carrier order and orders of slot harmonics, slit harmonics, and inverter harmonics in the 6-pole 36-slot reluctance motor illustrated in FIG. 4.

FIG. 11 is a diagram illustrating a relationship between the carrier order and the torque ripple in the 6-pole 36-slot reluctance motor illustrated in FIG. 4.

FIG. 12 is a cross-sectional view illustrating one magnetic pole of a 6-pole 54-slot reluctance motor as a reluctance motor having a structure different from that in FIG. 5.

FIG. 13 is a waveform diagram illustrating torque fluctuation at the time when the 6-pole 54-slot reluctance motor illustrated in FIG. 12 is driven with the carrier order 27.

FIG. 14 is a diagram illustrating a frequency analysis result of the torque fluctuation waveform illustrated in FIG. 13.

FIG. 15 is a diagram illustrating a frequency analysis result of a torque fluctuation waveform at the time when the 6-pole 54-slot reluctance motor illustrated in FIG. 12 is driven with the carrier order 17.

FIG. 16 is a diagram illustrating a frequency analysis result of a torque fluctuation waveform at the time when the 6-pole 54-slot reluctance motor illustrated in FIG. 12 is driven with the carrier order 15.

FIG. 17 is a diagram illustrating a relationship between the carrier order and the torque ripple in the 6-pole 54-slot reluctance motor illustrated in FIG. 12.

FIG. 18 is a diagram illustrating a relationship between the carrier order and orders of slot harmonics, slit harmonics, and inverter harmonics in the 6-pole 54-slot reluctance motor illustrated in FIG. 12.

FIG. 19 is a block diagram illustrating an example of a hardware configuration for implementing the functions of the control device according to the embodiment.

FIG. 20 is a block diagram illustrating another example of a hardware configuration for implementing the functions of the control device according to the embodiment.

### DESCRIPTION OF EMBODIMENTS

Hereinafter, a motor driver according to an embodiment of the present disclosure will be described in detail with reference to the accompanying drawings. In the following embodiment, a motor driver for driving a railway vehicle will be described as an example, but it is not intended to exclude application to other uses. In the accompanying drawings, the scale of each member may be different from the actual one for easy understanding.

Similarly, the scale of each member in some drawings may be different from that in other drawings.

### Embodiment

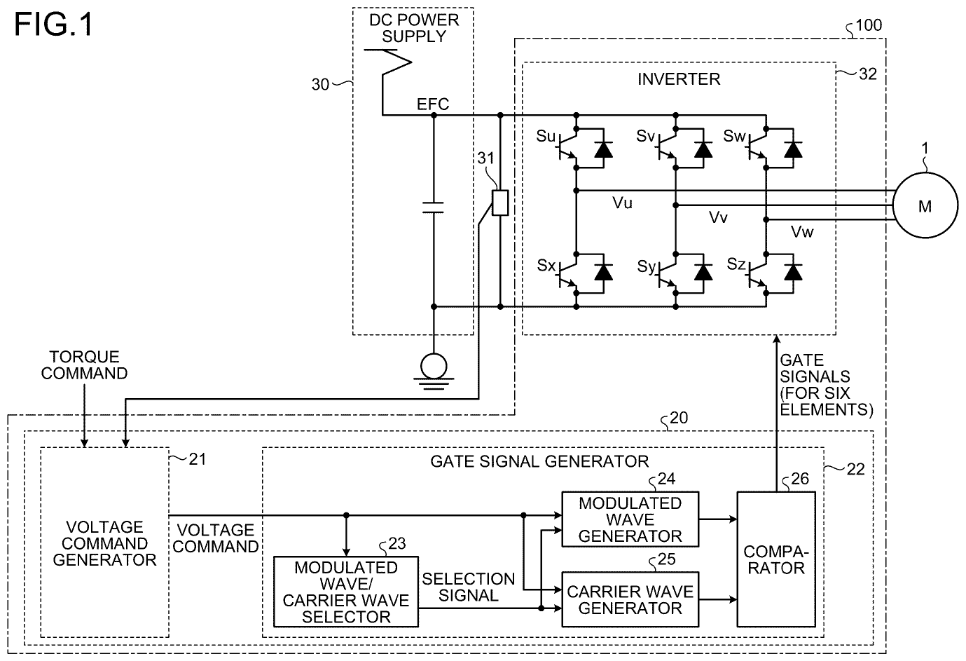

FIG. 1 is a diagram illustrating a configuration of a motor driver 100 according to an embodiment. In FIG. 1, motor driver 100 according to the embodiment includes an inverter 32 and a control device 20.

In FIG. 1, an AC motor 1 is a propulsion motor mounted on a railway vehicle. The AC motor 1 generates torque for driving the railway vehicle by AC power supplied from the inverter 32. The AC motor 1 is an induction motor or a synchronous motor.

A DC power supply 30 is a supply source of DC power to be supplied to the inverter 32. The DC power supply 30 includes an overhead line, a pantograph, a filter capacitor, and the like. The inverter 32 converts a DC voltage applied from the DC power supply 30 into an AC voltage and applies the AC voltage to the AC motor 1.

A DC voltage detector 31 for detecting a DC voltage output from the DC power supply 30 is provided between the DC power supply 30 and the inverter 32. The detection value of the DC voltage detected by the DC voltage detector 31 is output to the control device 20.

FIG. 1 illustrates an example in which the main circuit of the inverter 32 is a 2-level inverter. The inverter 32 is equipped with six semiconductor switching elements Su, Sv, Sw, Sx, Sy, and Sz, and includes the same number of arm circuits as the number of output phases. In the arm circuits, two of the semiconductor switching elements are connected in series, and the output voltage is an intermediate potential, which is a potential at the connection end of the two semiconductor switching elements. In FIG. 1, in order to obtain three-phase AC voltages Vu, Vv, and Vw, a u-phase arm consisting of the semiconductor switching elements Su and Sx, a v-phase arm consisting of the semiconductor switching elements Sv and Sy, and a w-phase arm consisting of the semiconductor switching elements Sw and Sz are configured. Note that the main circuit of the inverter 32 does not need to be a 2-level inverter, and may be, for example, a 3-level inverter.

The control device 20 includes a voltage command generator 21 and a gate signal generator 22. The gate signal generator 22 includes a modulated wave/carrier wave selector 23, a modulated wave generator 24, a carrier wave generator 25, and a comparator 26.

The voltage command generator 21 generates a voltage command based on the torque command and the detection value of the DC voltage. The gate signal generator 22 generates a gate signal for performing PWM control of the inverter 32 based on the voltage command output from the voltage command generator 21. In the example of FIG. 1, gate signals for performing PWM control of the six semiconductor switching elements Su, Sv, Sw, Sx, Sy, and Sz, that is, gate signals for the six elements, are generated and output to the inverter 32. From the inverter 32, the PWM-controlled three-phase AC voltages Vu, Vv, and Vw are generated and applied to the AC motor 1.

In the gate signal generator 22, the modulated wave generator 24 generates a modulated wave based on the voltage command output from the voltage command generator 21 and the selection signal output from the modulated wave/carrier wave selector 23. The carrier wave generator 25 generates a carrier wave based on the voltage command output from the voltage command generator 21 and the selection signal output from the modulated wave/carrier wave selector 23.

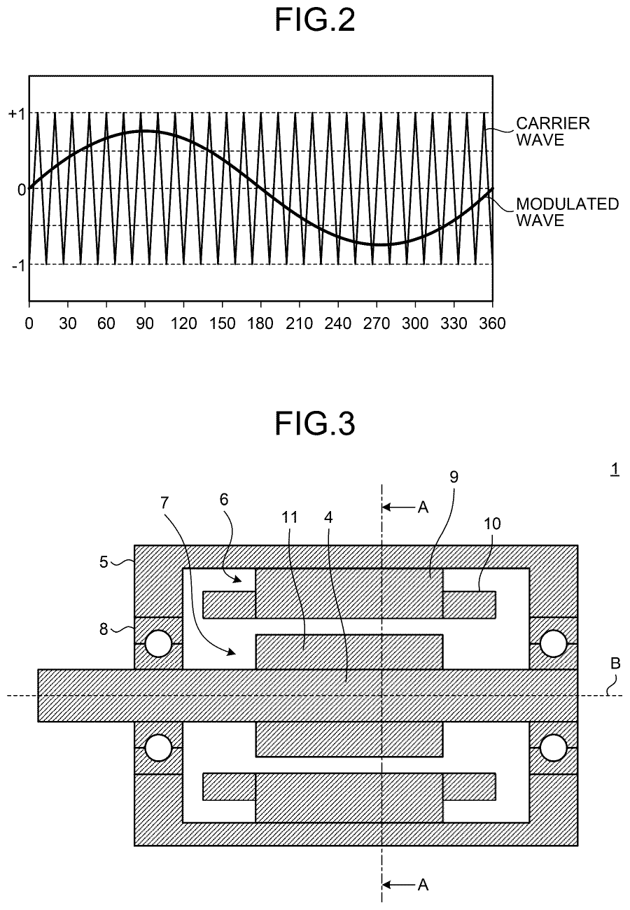

FIG. 2 is a diagram illustrating an example of the waveform of one phase of a modulated wave generated by the modulated wave generator 24 of FIG. 1 and the waveform of a carrier wave generated by the carrier wave generator 25 of FIG. 1. Here, the modulated wave is a waveform signal obtained by normalizing the command waveform of the motor-applied voltage that is applied to the AC motor 1 with the DC voltage of the DC power supply 30 in order to generate the gate signal. 8 As illustrated in FIG. 2, the frequency of the carrier wave is larger than the frequency of the modulated wave. FIG. 2 illustrates an example in which the frequency of the carrier wave is 27 times the frequency of the modulated wave. In this description, a numerical value obtained by normalizing the frequency of the carrier wave with the frequency of the modulated wave is referred to as a “carrier order”, and is represented by a symbol “Fc”. That is, FIG. 2 illustrates an example of a case where the selection signal having the carrier order Fc of 27 is output to the modulated wave generator 24 and the carrier wave generator 25 by the modulated wave/carrier wave selector 23. Note that the example of FIG. 2 is an example, and a value other than 27 may be selected as the carrier order by the selection signal.

The modulated wave/carrier wave selector 23 determines a selection signal for reducing the torque ripple generated in the AC motor 1 and outputs the selection signal to the modulated wave generator 24 and the carrier wave generator 25. The modulated wave generator 24 generates a modulated wave according to the selection signal output from the modulated wave/carrier wave selector 23. The carrier wave generator 25 generates a carrier wave according to the selection signal output from the modulated wave/carrier wave selector 23.

The comparator 26 generates the above-described gate signal based on the comparison result between the modulated wave and the carrier wave. Specifically, the comparator 26 compares the modulated wave output from the modulated wave generator 24 with the carrier wave output from the carrier wave generator 25 for each phase, and outputs a gate signal indicating:
(i) upper element: ON, lower element: OFF if amplitude of modulated wave>amplitude of carrier wave
(ii) upper element: OFF, lower element: ON if amplitude of modulated wave<amplitude of carrier wave. Note that the upper elements correspond to the semiconductor switching elements Su, Sv, and Sw, and the lower elements correspond to the semiconductor switching elements Sx, Sy, and Sz. The directions of the inequalities in the above (i) and (ii) may be reversed.

As described in the section of Background, torque ripple also increases due to harmonics that occur through PWM control of the inverter 32 that drives the AC motor 1. In this description, this harmonic is referred to as an “inverter harmonic”. The inverter harmonic is a harmonic that can be included in the AC voltage applied to the AC motor 1 through PWM control of the inverter 32. As described above, the modulated wave/carrier wave selector 23 determines the selection signal for reducing the torque ripple generated in the AC motor 1. A specific method of determining the selection signal for reducing the torque ripple generated in the AC motor 1 will be described later.

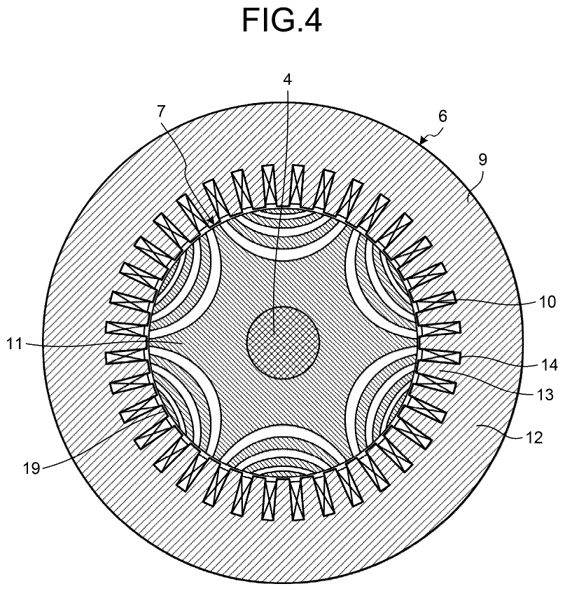

FIG. 3 is a cross-sectional view of the AC motor 1 according to the embodiment taken along the axial direction of a shaft 4. The broken line B illustrated in FIG. 3 is the axis of the shaft 4. FIG. 4 is a cross-sectional view of the AC motor 1 illustrated in FIG. 3 taken along line A-A in FIG. 3. FIGS. 3 and 4 illustrate a structure of a three-phase reluctance motor as an example of the AC motor 1. In FIG. 4, a frame 5 is not illustrated.

The AC motor 1 includes an annular stator 6 that is inserted into and fixed to the frame 5 with a method such as press fitting or shrink fitting, and a cylindrical rotor 7. The annular stator 6 and the cylindrical rotor 7 are disposed so as to be relatively rotatable via a magnetic gap 19 which is a mechanical gap using a bearing 8.

The stator 6 is configured by applying a winding 10 to an annular stator core 9 consisting of an iron core. The rotor 7 is integrally formed by inserting the shaft 4 into the center of a cylindrical rotor core 11 consisting of an iron core with a method such as press fitting or shrink fitting.

The stator core 9 includes an annular core back 12 and teeth 13 protruding radially inward from the core back 12 and arranged at equal intervals. A plurality of slots 14 are formed at equal intervals between the plurality of teeth 13 provided on the radially inner side of the stator core 9. The winding 10 is housed in the slots 14. The teeth 13 and the slots 14 are provided at the same angle in the circumferential direction of the annular shape. In this description, the whole of the plurality of slots 14 may be referred to as the “slot portion”.

In FIG. 4, given that the number of slots provided in the stator core 9 is S and the number of magnetic poles of the rotor core 11 is P, S=36 and P=6.

That is, FIG. 4 illustrates a cross-sectional structure of a 6-pole 36-slot three-phase reluctance motor. The number of slots and the number of magnetic poles illustrated in FIG. 4 are examples, and are not limited to the example of FIG. 4.

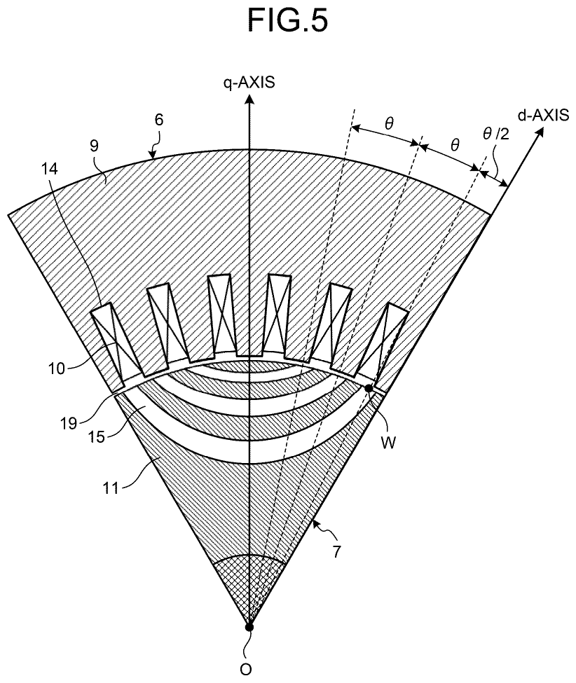

FIG. 5 is a cross-sectional view illustrating one magnetic pole of the 6-pole 36-slot reluctance motor illustrated in FIG. 4, and is an enlarged view of a 1/6 region in FIG. 4. As illustrated in FIG. 5, the stator 6 of the 6-pole 36-slot reluctance motor includes six slots 14 per magnetic pole.

In FIG. 5, on the cross section of the stator core 9 and the rotor core 11, a d-axis is defined in the center line direction of the magnetic poles, and a q-axis is defined in the center line direction between the magnetic poles. The center line direction of the magnetic poles is a direction in which the magnetic flux is likely to pass, and the center line direction between the magnetic poles is a direction in which the magnetic flux is unlikely to pass. The d-axis direction may be referred to as a “salient pole direction”, and the q-axis direction may be referred to as a “non-salient pole direction”.

The d-axis and the q-axis electrically have a phase difference of 90 degrees. The rotor 7 rotates by an inductance torque generated based on a difference in inductance between the d-axis direction and the q-axis direction. That is, the reluctance motor generates output torque by using a difference in magnetic resistance in the rotation direction. Therefore, the reluctance motor can generate higher output torque as the difference in inductance between the d-axis and the q-axis is larger.

In FIG. 5, when viewed in the direction of the central axis of the cylinder, the rotor core 11 is equipped with a plurality of slits 15 each consisting of an arc-shaped opening that is convex toward a cylinder center O of the rotor core 11 for each magnetic pole of the rotor core 11 and has an apex positioned on the q-axis. A space is provided in the rotor core 11 by the plurality of slits 15. That is, the slits 15 cause the rotor core 11 to have a structure in which a magnetic portion including a magnetic material which is a material of an electromagnetic steel sheet and a non-magnetic portion formed of air alternately appear. The slits 15 are provided so as to be symmetric with respect to the q-axis for each magnetic pole. In this description, the whole of the plurality of slits 15 may be referred to as the “slit portion”.

FIG. 5 illustrates a case where the number of slits 15 is three, but the number is not limited to this, and may be two or four or more. That is, the number of slits 15 only needs to be more than one. Further, in FIG. 5, the end portions of the slits 15 are linearly formed along the side portion located on the magnetic gap 19 side of the rotor core 11, but are not limited to this shape. The end portions of the slits 15 may be chamfered in an arc shape. Note that, for example, an arc shape approximately simulated by a straight line or the like can also be regarded as an arc-like shape.

A midpoint in the circumferential direction of the arc-shaped end portion along the outer circumferential surface of the rotor core 11 in the arc-shaped opening portion of the slit 15 closest to the d-axis passing through the cylinder center O of the rotor core 11 is defined as a center point W. An angle formed by the center points W of the slits 15 each provided in one magnetic pole with respect to the cylinder center O of the rotor core 11 between adjacent slits is defined as θ.

In the examples of FIGS. 4 and 5, the slits 15 are provided such that the angle θ is equal between adjacent slits. Further, an angle formed by a straight line connecting the center point W of the slit closest to the d-axis and the cylinder center O of the rotor core 11 and the d-axis is set to be θ/2. When the angle θ is equal between adjacent slits, the angle θ is set to θ=6.67 (=360/54) degrees. In this description, the angle θ may be referred to as the “slit interval θ”, and the number of angles θ in the entire circumference of the rotor core 11 may be referred to as the “pitch number”. In the case of the configuration of FIG. 5, the number of pitches is 54. Note that the configuration of FIG. 5 is an example, and the slit interval θ does not necessarily have to be equal between adjacent slits.

As described above, the rotor core 11 has a configuration in which the core portion having low magnetic resistance through which the magnetic flux is likely to pass and the slit portion having high magnetic resistance through which the magnetic flux is unlikely to pass alternately appear in the rotation direction. Due to such a fluctuation in the magnetoresistance of the rotor core 11, harmonics are superimposed on the winding 10. In this description, harmonics generated by the fluctuation of the magnetoresistance in the rotation direction in the rotor core 11 are referred to as “slit harmonics”.

In addition, in FIG. 5, when the stator core 9 is viewed from the rotor core 11, also in the stator core 9, the core portion having low magnetic resistance through which the magnetic flux is likely to pass and the slot portion having high magnetic resistance through which the magnetic flux is unlikely to pass alternately appear in the rotation direction. Due to such a fluctuation in the magnetoresistance of the stator core 9, harmonics are superimposed on the winding 10. In this description, harmonics generated by the fluctuation of the magnetoresistance in the rotation direction in the stator core 9 are referred to as “slot harmonics”.

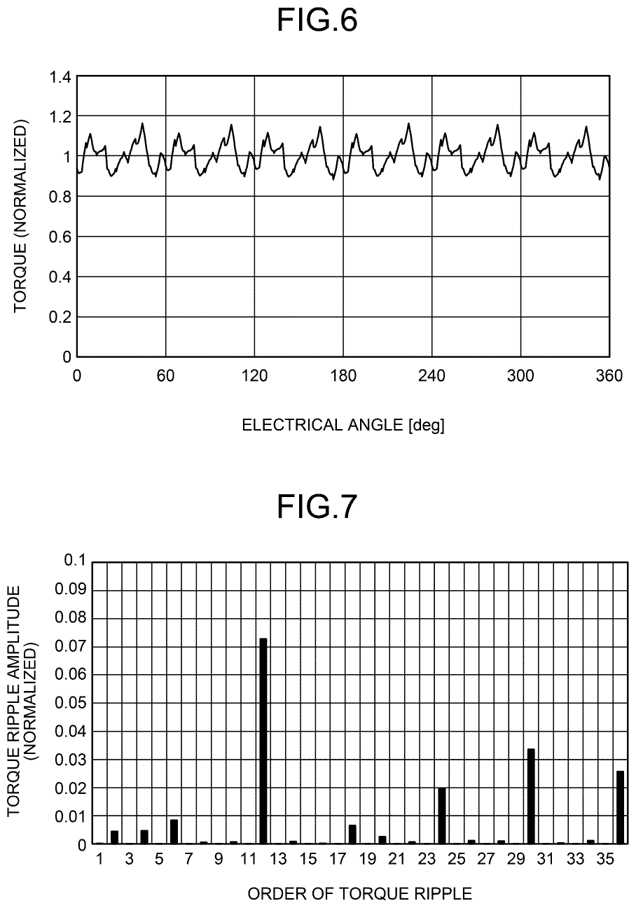

FIG. 6 is a waveform diagram illustrating torque fluctuation at the time when the 6-pole 36-slot reluctance motor illustrated in FIG. 4 is driven with the carrier order 27. In FIG. 6, the horizontal axis represents the electrical angle, and the vertical axis represents the magnitude of the torque applied to the AC motor 1 in a normalized manner. FIG. 7 is a diagram illustrating a frequency analysis result of the torque fluctuation waveform illustrated in FIG. 6. In FIG. 7, the horizontal axis represents the order of the torque ripple, and the vertical axis represents the torque ripple amplitude that is the amplitude value of the torque ripple. The order of the torque ripple is a numerical value obtained by normalizing one of the frequencies of the torque ripple with the frequency of the modulated wave and shown as a multiple of the normalized frequency. In addition, the vertical axis represents a value obtained by normalizing the amplitude for each order of the torque ripple with the magnitude of the entire torque ripple over the entire frequency band.

First, as is shown in FIG. 6 the value of the torque fluctuates when the electrical angle, equivalent to the rotational position of the rotor 7, is different. In addition, FIG. 7 shows that the torque ripples of the 12-th order, the 18-th order, the 24-th order, the 30-th order, and the 36-th order are large, excluding the sixth and lower orders. Among the torque ripples in these orders, the 12-th, 24-th, and 36-th harmonics correspond to slot harmonics. The AC motor 1 illustrated in FIG. 4 has a 6-pole 36-slot configuration, and the number of slots per pole is six. Therefore, the order of the fundamental frequency of the slot harmonic is the 12 order, and the 24 order and the 36 order, which are integral multiples of the 12 order, also correspond to the slot harmonics. The number of pitches of the AC motor 1 illustrated in FIG. 4 is 54, which corresponds to 1.5 times the number of slots S=36 in the entire circumference of the stator core 9. Therefore, the order of the fundamental frequency of the slit harmonic is the 18 order, and the 36 order, which is an integral multiple of the 18 order, also corresponds to the slit harmonic.

Through this study, the inventors of the present application have found that the orders of the inverter harmonics that greatly affect the torque ripple among the plurality of inverter harmonics are (Fc−3), (Fc+3), and 2Fc. In the case of FIG. 7, the 24-th order corresponds to the (Fc−3)-th order, and the 30-th order corresponds to the (Fc+3)-th order. Note that the 2Fc order has a large value of the order and is not included in the analysis result of FIG. 7.

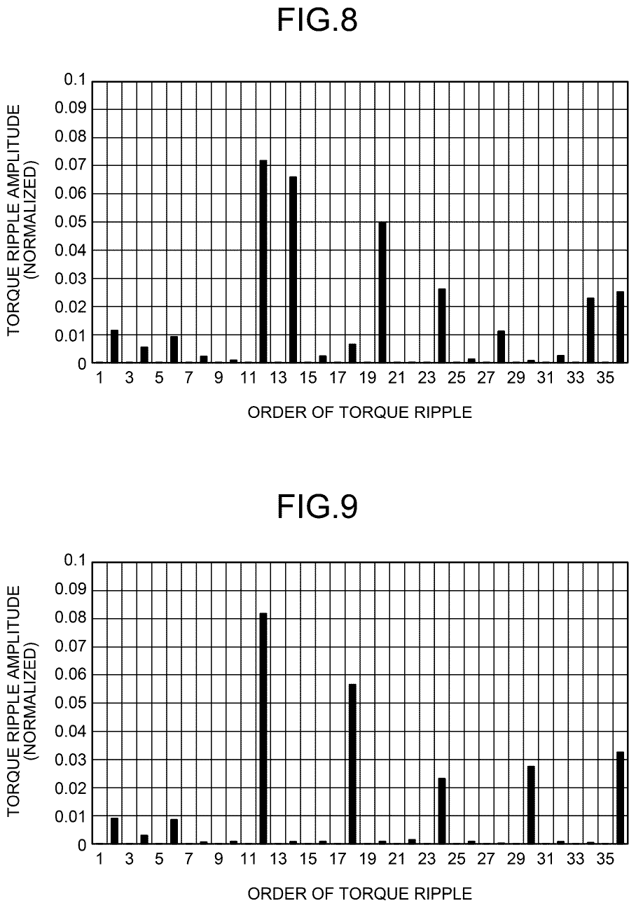

According to the analysis result of FIG. 7, in which the 30-th-order component greatly appears, it can be understood that the (Fc+3)-th order is the inverter harmonic. On the other hand, the 24-th order corresponding to the (Fc−3)-th order is overlapped with the slot harmonic and cannot be distinguished. Therefore, frequency analysis was performed with different carrier orders. The analysis results are shown in FIGS. 8 and 9. Specifically, FIG. 8 is a diagram illustrating a frequency analysis result of a torque fluctuation waveform at the time when the 6-pole 36-slot reluctance motor illustrated in FIG. 4 is driven with the carrier order 17, and FIG. 9 is a diagram illustrating a frequency analysis result of a torque fluctuation waveform at the time when the 6-pole 36-slot reluctance motor illustrated in FIG. 4 is driven with the carrier order 15.

According to the analysis result of FIG. 8, similarly to FIG. 7, the 12-th, 24-th, and 36-th slot harmonics and the 18-th and 36-th slit harmonics are generated. In the analysis result of FIG. 8, the 14-th, 20-th, and 34-th harmonics are generated, but the 14-th 16 harmonic corresponds to the (Fc−3)-th harmonic, the 20-th harmonic corresponds to the (Fc+3)-th harmonic, and the 34-th harmonic corresponds to the (2Fc)-th harmonic. Here, it can be understood that the 14-th order is an order component that belongs to neither the slot harmonic nor the slit harmonic, and the 14-th order is the (Fc−3)-th order of the inverter harmonic. In addition, the 34-th order is also an order component that belongs to neither the slot harmonic nor the slit harmonic, and it can be understood that the 34-th order component that is the 2Fc order as the inverter harmonic is also a component that greatly affects the torque ripple.

According to the analysis result of FIG. 9, similarly to FIG. 7, the 12-th, 24-th, and 36-th slot harmonics; and the 18-th and 36-th slit harmonics are generated. In the analysis result of FIG. 9, the 12-th, 18-th, and 30-th inverter harmonics are generated, and the 12-th harmonic corresponds to the (Fc−3)-th harmonic, the 18-th harmonic corresponds to the (Fc+3)-th harmonic, and the 30-th harmonic corresponds to the (2Fc)-th harmonic. The 12-th order and the 18-th order cannot be distinguished from the slot harmonic and the slit harmonic, but the 30-th order is a component of only the inverter harmonic, and from this result, it can be understood that the 30-th order component that is the 2Fc order has a large influence on the torque ripple.

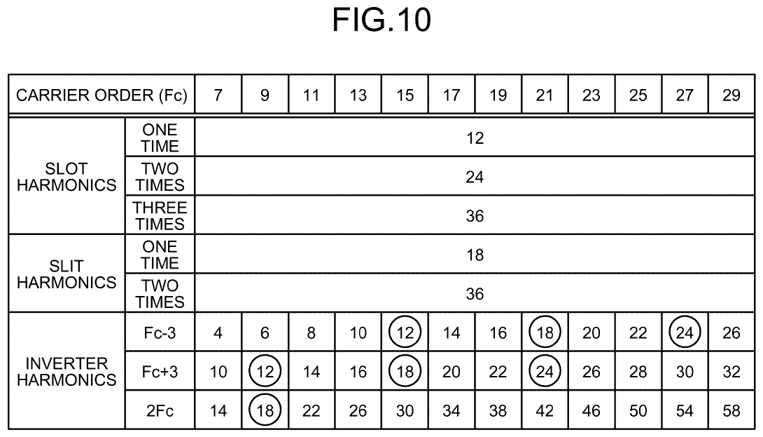

FIG. 10 is a diagram illustrating a relationship between the carrier order Fc and orders of slot harmonics, slit harmonics, and inverter harmonics in the 6-pole 36-slot reluctance motor illustrated in FIG. 4. Note that matching orders appear in much higher orders, but these are not the main components of the torque ripple, and thus are not illustrated. Furthermore, FIG. 10 illustrates only a case where the carrier order Fc is an odd number, that is, a case where the frequency of the carrier wave is an odd multiple of the frequency of the modulated wave. This is because when the carrier order Fc is an even number, the N pole and the S pole of the magnetic pole are not symmetrical, and the pulse of the PWM signal is not a synchronization pulse.

In FIG. 10, a circled portion indicates that the order overlaps with at least one of the slot harmonic and the slit harmonic. In the case of the carrier order Fc=27, as described with reference to FIG. 7, two times (24-th order) of the slot harmonic matches Fc−3 (24-th order) of the inverter harmonic. In addition, in the case of the carrier order Fc=17, as described with reference to FIG. 8, there is no matching order. In addition, in the case of the carrier order Fc=15, as described with reference to FIG. 9, one time (12-th order) of the slot harmonic matches Fc−3 (12-th order) of the inverter harmonic, and one time (18-th order) of the slit harmonic matches Fc+3 (18-th order) of the inverter harmonic.

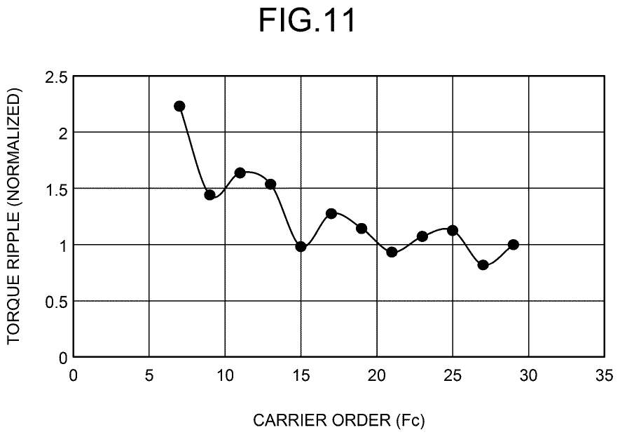

FIG. 11 is a diagram illustrating a relationship between the carrier order Fc and the torque ripple in the 6-pole 36-slot reluctance motor illustrated in FIG. 4. In FIG. 11, the horizontal axis represents the carrier order Fc, and the vertical axis represents a value obtained by normalizing the torque ripple with the 29-th order having the largest carrier order Fc. FIG. 11 shows that the torque ripple decreases as the carrier order Fc increases. In addition, FIG. 11 also shows that given n is a natural number, the torque ripple has the minimum value when the carrier order Fc is 6n+3. Specifically, in FIG. 11, the torque ripple has the minimum value when Fc=9 (n=1), Fc=15 (n=2), Fc=21 (n=3), and Fc=27 (n=4).

Considering the results of FIGS. 10 and 11 described above, the following can be said. First, as illustrated in FIG. 10, when the carrier order Fc is 6n+3 (n=1 to 4), there is an order that matches the inverter harmonic in at least one of the slot harmonic and the slit harmonic. Further, comparing the analysis result of FIG. 8 in which the carrier order Fc is 17 with the analysis result of FIG. 9 in which the carrier order Fc is 15, and referring to the result of FIG. 11, it can be seen that the torque ripple decreases when there is an order that matches the inverter harmonic in at least one of the slot harmonic and the slit harmonic. When there is an order that matches the inverter harmonic in at least one of the slot harmonic and the slit harmonic, it means that the number of orders in which torque ripple is generated is reduced as viewed from the entire torque ripple. As a result, it is considered that the torque ripple is reduced.

In addition, in a case where the carrier order Fc is 27, although there is no matching order between the inverter harmonic and the slit harmonic, the torque ripple has the minimum value as illustrated in the result of FIG. 11, and the effect of reducing the torque ripple can be obtained. Therefore, it can be seen that the method described in the present embodiment provides an effect as long as the AC motor has a configuration including a stator core in which a plurality of slots are formed on the inner circumferential surface. Therefore, the technique of the present embodiment is not limited to the reluctance motor, and even when the technique is applied to a permanent magnet motor or an induction motor, it is possible to enjoy the effect of reducing the torque ripple.

The above description relates to the 6-pole 36-slot reluctance motor illustrated in FIGS. 4 and 5. In order to confirm the contents described above, analysis was also performed on a reluctance motor having another structure. The details will be described below.

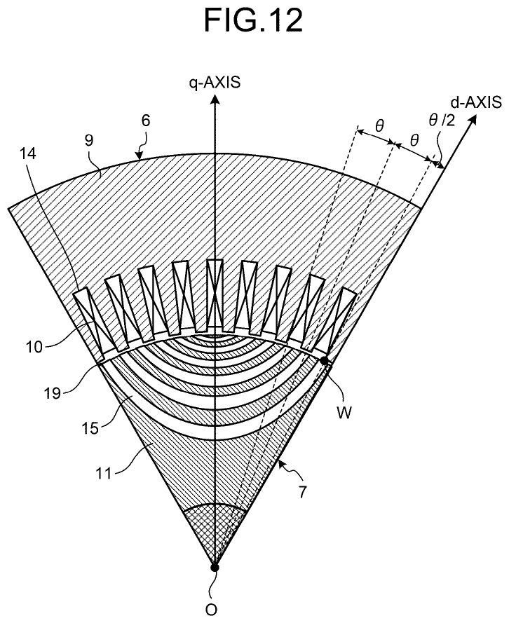

FIG. 12 is a cross-sectional view illustrating one magnetic pole of a 6-pole 54-slot reluctance motor as a reluctance motor having a structure different from that in FIG. 5. The number of pitches of the rotor core 11 is 72, and the slit interval θ is θ=5.0 (=360/72) degrees. In this structure, the fundamental frequency of the slit harmonic is 4/3 times the fundamental frequency of the slot harmonic.

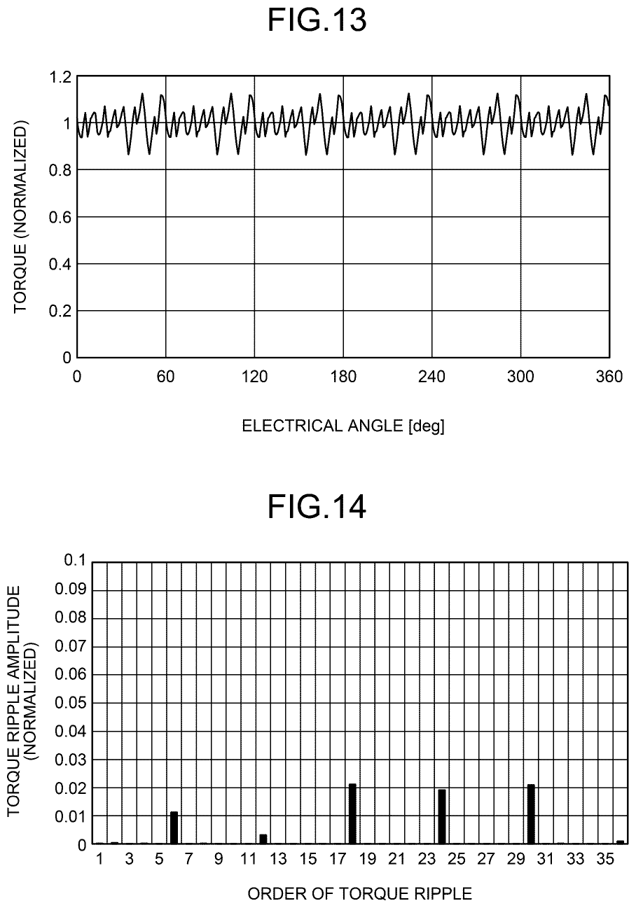

FIG. 13 is a waveform diagram illustrating torque fluctuation at the time when the 6-pole 54-slot reluctance motor illustrated in FIG. 12 is driven with the carrier order 27. The notation of the vertical axis and the horizontal axis is the same as that in FIG. 6. As in FIG. 6, FIG. 13 shows that the value of the torque fluctuates when the electrical angle equivalent to the rotational position of the rotor 7 is different.

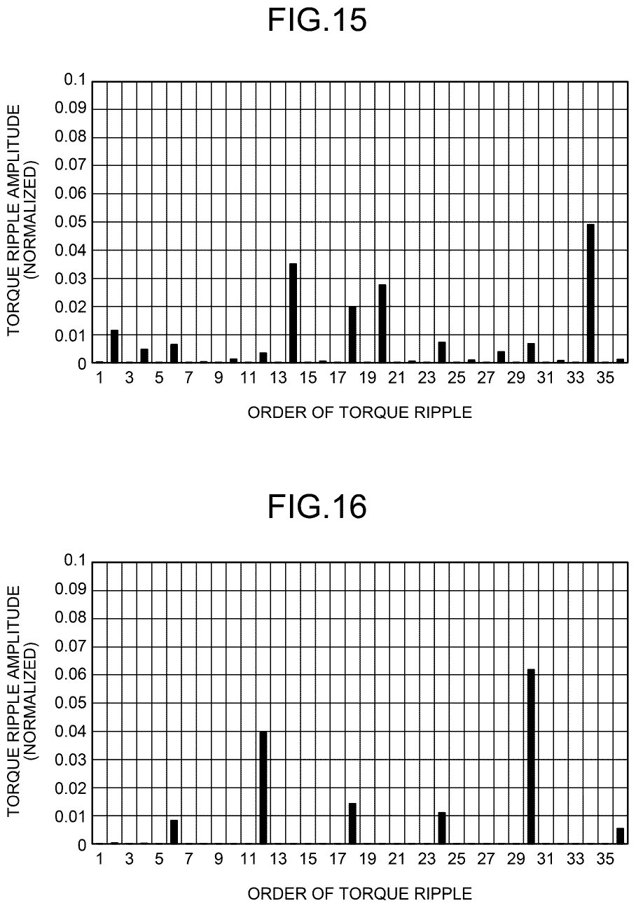

FIG. 14 is a diagram illustrating a frequency analysis result of the torque fluctuation waveform illustrated in FIG. 13. The notation of the vertical axis and the horizontal axis is the same as that in FIG. 7. FIG. 14 shows that the torque ripples of the 12-th order, the 18-th order, the 24-th order, and the 30-th order are large, excluding the sixth and lower orders. Among the torque ripples in these orders, the 18-th harmonic corresponds to the slot harmonic, and the 30-th harmonic corresponds to the inverter harmonic. The 24-th harmonic is considered to correspond to both the slit harmonic and the inverter harmonic, but cannot be distinguished from only the analysis result of FIG. 14. Therefore, frequency analysis was performed with different carrier orders. The analysis results are shown in FIGS. 15 and 16. Specifically, FIG. 15 is a diagram illustrating a frequency analysis result of a torque fluctuation waveform at the time when the 6-pole 54-slot reluctance motor illustrated in FIG. 12 is driven with the carrier order 17, and FIG. 16 is a diagram illustrating a frequency analysis result of a torque fluctuation waveform at the time when the 6-pole 54-slot reluctance motor illustrated in FIG. 12 is driven with the carrier order 15.

According to the analysis result of FIG. 15, the 18-th slot harmonic and the 24-th slit harmonic are generated. In the analysis result of FIG. 15, the 14-th, 18-th, 20-th, 24-th, 30-th, and 34-th harmonics are generated; and the 14-th harmonic corresponds to the (Fc−3)-th harmonic, the 20-th harmonic corresponds to the (Fc+3)-th harmonic, and the 34-th harmonic corresponds to the (2Fc)-th harmonic. Here, it can be understood that the 14-th order is an order component that belongs to neither the slot harmonic nor the slit harmonic, and the 14-th order is the (Fc−3)-th order of the inverter harmonic. In addition, it can be understood that the 20-th order is also an order that belongs to neither the slot harmonic nor the slit harmonic, and the 20-th order is the (Fc+3) order of the inverter harmonic. Furthermore, it can be understood that the 34-th order is also an order that belongs to neither the slot harmonic nor the slit harmonic, and the 34-th order is the (Fc+3) order of the inverter harmonic.

According to the analysis result of FIG. 16, the 18-th and 36-th slot harmonic and the 24-th slit harmonic are generated. In addition, in the analysis result of FIG. 16, harmonics of the 12-th, 18-th, 24-th, 30-th, and 36-th orders are generated; and the 12-th order corresponds to the (Fc−3)-th order and the 30-th order corresponds to the (2Fc)-th order. Here, it can be understood that the 12-th order is an order component that belongs to neither the slot harmonic nor the slit harmonic, and the 12-th order is the (Fc−3)-th order of the inverter harmonic. In addition, it can be understood that the 30-th order is also an order component that belongs to neither the slot harmonic nor the slit harmonic, and the 30-th order is the (2Fc)-th order component of the inverter harmonic. Furthermore, from the above description, it can be seen that the 18-th order is the component of the fundamental wave of the slot harmonic and is also the (Fc−3)-th order component of the inverter harmonic.

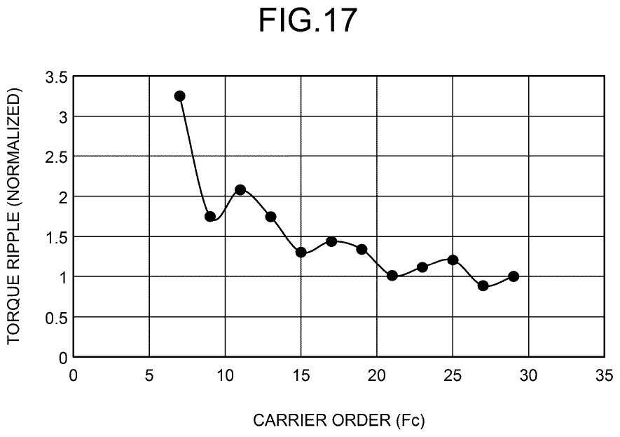

FIG. 17 is a diagram illustrating a relationship between the carrier order Fc and the torque ripple in the 6-pole 54-slot reluctance motor illustrated in FIG. 12. As in FIG. 11, the horizontal axis represents the carrier order Fc, and the vertical axis represents a value obtained by normalizing the torque ripple with the 29-th order having the largest carrier order Fc. As in FIG. 11, FIG. 17 shows that the torque ripple decreases as the carrier order Fc increases. As in FIG. 11, given n is a natural number, the relationship in which the torque ripple has the minimum value when the carrier order Fc is 6n+3 is maintained.

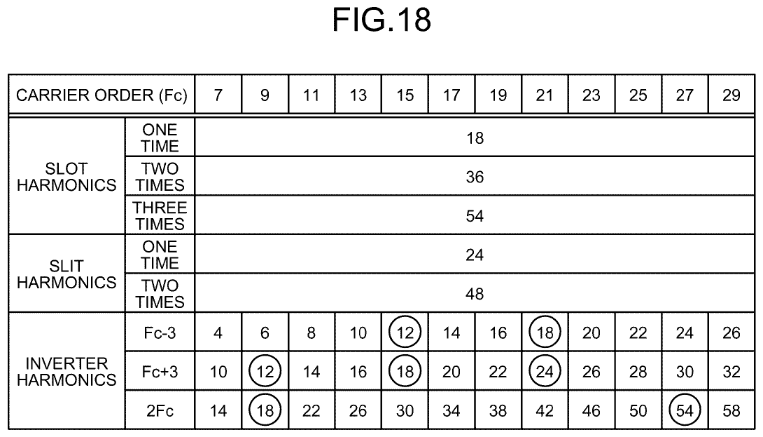

FIG. 18 is a diagram illustrating a relationship between the carrier order Fc and orders of slot harmonics, slit harmonics, and inverter harmonics in the 6-pole 54-slot reluctance motor illustrated in FIG. 12. Similarly to FIG. 10, high-order components are not illustrated. In addition, similarly to FIG. 10, only the case where the carrier order Fc is an odd number is described.

Considering the results of FIGS. 10, 11, 17, and 18 described above, the following can be said. First, regardless of whether the structure of the stator core 9 is the 6-pole 36-slot or the 6-pole 54-slot, the relationship in which the torque ripple has the minimum value when the carrier order Fc is 6n+3 is maintained. This relationship is considered to be because the number of slots per pole is a natural number multiple of three in both the 6-pole 36-slot and the 6-pole 54-slot. Actually, the number of slots per pole of the 6-pole 36-slot is six, the number of slots per pole of the 6-pole 54-slot is nine, and the number of slots per pole is a natural number multiple of three. When the stator core 9 is viewed from the rotor core 11, since the core portion having low magnetic resistance and the slot portion having high magnetic resistance alternately appear in the rotation direction, it can be understood that there is periodicity in which the torque ripple has the minimum value at a location that is a natural number multiple of six.

Based on the premise of the above description, the gate signal generator 22 included in the control device 20 according to the embodiment performs the following control. Here, a numerical value obtained by normalizing the frequency of one harmonic of the plurality of inverter harmonics with the frequency of the modulated wave is referred to as the “primary order”; a numerical value obtained by normalizing the frequency of one harmonic of the plurality of slot harmonics with the frequency of the modulated wave is referred to as the “secondary order”; and a numerical value obtained by normalizing the frequency of one harmonic of the plurality of slit harmonics with the frequency of the modulated wave is referred to as the “tertiary order”.

First, when generating a gate signal for performing PWM control of the inverter 32, the gate signal generator 22 generates the gate signal such that the primary order matches the secondary order. With this control method, the frequency of at least one harmonic of the slot harmonics and the frequency of at least one harmonic of the inverter harmonics can be matched. As a result, the number of orders in which torque ripple occurs can be reduced, and thus torque ripple can be reduced.

In the above control method, since the frequency of the modulated wave is determined by the voltage command value, setting the frequency of the carrier wave appropriately can generate a gate signal that matches the primary order with the secondary order. In addition, this control method does not significantly affect existing control, and does not require complicated calculation processing unlike in Patent Literature 1. Therefore, by using this control method, it is possible to reduce torque ripple while suppressing an increase in processing time and processing load. In addition, by using this control method, since it is not necessary to modify the structure of the AC motor, it is possible to solve the demands for torque ripple through inverter control while promoting the use of existing AC motors in various applications that have various demands for torque ripple.

Furthermore, in a case where the AC motor is a reluctance motor including a rotor core equipped with a plurality of slits, the gate signal generator 22 generates a gate signal such that the primary order matches at least one of the secondary order and the tertiary order when generating a gate signal for performing PWM control of the inverter 32. With this control method, the frequency of at least one harmonic of the slot harmonics and the slit harmonics and the frequency of at least one harmonic of the inverter harmonics can be matched. As a result, the number of orders in which torque ripple occurs can be reduced, and thus torque ripple can be reduced. In addition, this control method does not significantly affect existing control, and does not require complicated calculation processing unlike in Patent Literature 1; therefore, it is possible to reduce torque ripple while suppressing an increase in processing time and processing load.

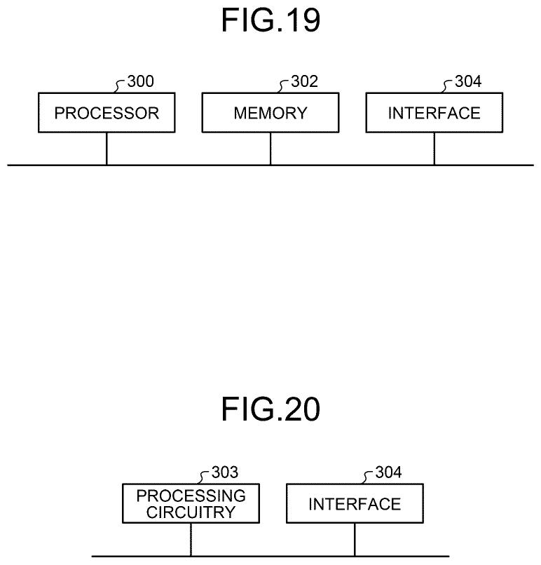

Next, hardware configurations for implementing the functions of the control device 20 mentioned above will be described with reference to the drawings of FIGS. 19 and 20. FIG. 19 is a block diagram illustrating an example of a hardware configuration for implementing the functions of the control device 20 according to the embodiment. FIG. 20 is a block diagram illustrating another example of a hardware configuration for implementing the functions of the control device 20 according to the embodiment.

Some or all of the functions of the control device 20 according to the embodiment can be implemented with a configuration including a processor 300, a memory 302, and an interface 304 as illustrated in FIG. 19. The processor 300 performs calculation. Programs that are read by the processor 300 are saved in the memory 302. Signals are input and output through the interface 304.

The processor 300 is a calculation means. The processor 300 may be a calculation means called a microprocessor, a microcomputer, a central processing unit (CPU), or a digital signal processor (DSP). The memory 302 can be exemplified by a non-volatile or volatile semiconductor memory, a magnetic disk, a flexible disk, an optical disc, a compact disc, a mini disc, a digital versatile disc (DVD), or the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

The memory 302 stores a program for executing the functions of the control device 20 according to the embodiment. Necessary information is sent and received via the interface 304, the processor 300 executes the program stored in the memory 302, and the processor 300 refers to data stored in the memory 302, whereby the processor 300 can execute above-described processing. The calculation result by the processor 300 can be stored in the memory 302.

For implementing some of the functions of the control device 20 according to the embodiment, a processing circuitry 303 illustrated in FIG. 20 can also be used. For example, the processing circuitry 303 is a single circuit, a composite circuit, an application specific integrated circuit (ASIC), a field-programmable gate array (FPGA), or a combination thereof. Information input to the processing circuitry 303 and information output from the processing circuitry 303 can be obtained via the interface 304.

Note that some processing in the control device 20 may be performed by the processing circuitry 303, and processing not performed by the processing circuitry 303 may be performed by the processor 300 and the memory 302.

As described above, the motor driver according to the embodiment includes an inverter, a DC voltage detector, a voltage command generator, and a gate signal generator. The inverter converts a DC voltage into an AC voltage and applies the AC voltage to the AC motor. The DC voltage detector detects a DC voltage applied to the inverter. The voltage command generator generates a voltage command based on a torque command and a detection value of the DC voltage. The gate signal generator generates a gate signal for performing pulse width modulation control of the inverter based on a comparison result between a modulated wave that is a waveform of a voltage command and a carrier wave. The AC motor includes an annular stator core in which a plurality of slots arranged at equal intervals along an inner circumferential surface are formed. The number of slots per magnetic pole in the stator core of the AC motor is a natural number multiple of three. A numerical value obtained by normalizing the frequency of the carrier wave with the frequency of the modulated wave is represented by Fc as a carrier order, and n is natural number. At this time, the gate signal generator generates the gate signal such that there is a relationship of Fc=6n+3 between Fc and n. When the inverter is controlled with this gate signal, the frequency of at least one harmonic of the slot harmonics and the frequency of at least one harmonic of the inverter harmonics can be matched. As a result, it is possible to obtain a motor driver that can reduce torque ripple while suppressing an increase in processing time and processing load.

In addition, in the motor driver according to the embodiment, the primary order is a numerical value obtained by normalizing the frequency of one harmonic of a plurality of inverter harmonics that can be included in the AC voltage applied to the AC motor by performing pulse width modulation control of the inverter with the frequency of the modulated wave. The secondary order is a numerical value obtained by normalizing the frequency of one harmonic of a plurality of slot harmonics generated by fluctuation of magnetoresistance in a rotation direction in the stator core with the frequency of the modulated wave. At this time, the gate signal generator included in the motor driver generates the gate signal such that the primary order matches the secondary order. As a result, the frequency of at least one harmonic of the slot harmonics and the frequency of at least one harmonic of the inverter harmonics can be matched, and thus the number of orders in which torque ripple occurs can be reduced, and torque ripple can be reduced.

In the above control, the primary order is any one of an order obtained by subtracting 3 from the carrier order, an order obtained by adding 3 to the carrier order, or an order obtained by doubling the carrier order. In addition, the secondary order is any one of an order corresponding to the frequency of a fundamental wave among a plurality of slot harmonics, an order corresponding to a frequency twice the fundamental wave among a plurality of slot harmonics, and an order corresponding to a frequency three times the fundamental wave among a plurality of slot harmonics. These components are main components in the inverter harmonics and the slot harmonics. Therefore, the control for reducing torque ripple can be effectively performed.

In addition, in the motor driver according to the embodiment, the AC motor to be driven is a reluctance motor including a rotor core equipped with a plurality of slits each consisting of an arc-shaped opening that is convex toward a cylinder center for each magnetic pole as viewed in a central axis direction of a cylinder and has an apex positioned on a q-axis. The tertiary order is a numerical value obtained by normalizing the frequency of one harmonic of a plurality of slit harmonics generated by fluctuation of magnetoresistance in a rotation direction in the rotor core with the frequency of the modulated wave. At this time, the gate signal generator included in the motor driver generates the gate signal such that the primary order matches at least one of the secondary order and the tertiary order. As a result, the frequency of at least one harmonic of the slot harmonics and the slit harmonics and the frequency of at least one harmonic of the inverter harmonics can be matched, and thus the number of orders in which torque ripple occurs can be reduced, and torque ripple can be reduced.

In the above control, the primary order is any one of an order obtained by subtracting 3 from the carrier order, an order obtained by adding 3 to the carrier order, or an order obtained by doubling the carrier order. In addition, the secondary order is any one of an order corresponding to the frequency of a fundamental wave among a plurality of slot harmonics, an order corresponding to a frequency twice the fundamental wave among a plurality of slot harmonics, and an order corresponding to a frequency three times the fundamental wave among a plurality of slot harmonics. The tertiary order is any one of an order corresponding to the frequency of a fundamental wave among a plurality of slit harmonics and an order corresponding to a frequency twice the fundamental wave among a plurality of slit harmonics. These components are main components in the inverter harmonics, the slot harmonics, and the slit harmonics. Therefore, the control for reducing torque ripple can be effectively performed.

The configurations described in the above-mentioned embodiment indicate examples. The configurations can be combined with another well-known technique, and some of the configurations can be omitted or changed in a range not departing from the gist.

### Reference Signs List

1 AC motor; 4 shaft; 5 frame; 6 stator; 7 rotor; 8 bearing; 9 stator core; 10 winding; 11 rotor core; 12 core back; 13 teeth; 14 slot; 15 slit; 19 magnetic gap; 20 control device; 21 voltage command generator; 22 gate signal generator; 23 modulated wave/carrier wave selector; 24 modulated wave generator; 25 carrier wave generator; 26 comparator; 30 DC power supply; 31 DC voltage detector; 32 inverter; 100 motor driver; 300 processor; 302 memory; 303 processing circuitry; 304 interface; Su, Sv, Sw, Sx, Sy, Sz semiconductor switching element.

1. A motor driver adapted to drive an AC motor having a stator core in which a plurality of slots arranged at equal intervals along an inner circumferential surface are formed, the motor driver comprising:
an inverter adapted to convert a DC voltage into an AC voltage and apply the AC voltage to the AC motor;
a DC voltage detector adapted to detect the DC voltage applied to the inverter;
a voltage command generator adapted to generate a voltage command based on a torque command and a detection value of the DC voltage; and
a gate signal generator adapted to generate a gate signal for performing pulse width modulation control of the inverter based on a comparison result between a modulated wave that is a waveform of the voltage command and a carrier wave, wherein
number of slots per magnetic pole in the stator core is a natural number multiple of three, and
there is a relationship of Fc=6n+3 between Fc and n, where Fc represents a numerical value as a carrier order obtained by normalizing frequency of the carrier wave with frequency of the modulated wave, and n is natural number.

2. The motor driver according to claim 1, wherein
the gate signal generator adapted to generate the gate signal such that a primary order matches a secondary order,
where the primary order is a numerical value obtained by normalizing frequency of one harmonic of a plurality of inverter harmonics that can be included in the AC voltage applied to the AC motor by performing pulse width modulation control of the inverter with the frequency of the modulated wave, and
the secondary order is a numerical value obtained by normalizing frequency of one harmonic of a plurality of slot harmonics generated by fluctuation of magnetoresistance in a rotation direction in the stator core with the frequency of the modulated wave.

3. The motor driver according to claim 2, wherein
the primary order is any one of an order obtained by subtracting 3 from the carrier order, an order obtained by adding 3 to the carrier order, or an order obtained by doubling the carrier order, and
the secondary order is any one of an order corresponding to frequency of a fundamental wave among a plurality of slot harmonics, an order corresponding to a frequency twice the fundamental wave among a plurality of slot harmonics, and an order corresponding to a frequency three times the fundamental wave among a plurality of slot harmonics.

4. The motor driver according to claim 2, wherein
the AC motor is a reluctance motor including a rotor core, the rotor core:
has a cylindrical shape;
is disposed on an inner surface side of the stator core; and
is equipped with a plurality of slits each consisting of an arc-shaped opening that is convex toward a cylinder center for each magnetic pole as viewed in a central axis direction of a cylinder and has an apex positioned on a q-axis, and
the gate signal generator is adapted to generate the gate signal such that the primary order matches the tertiary order,
where the tertiary order is a numerical value obtained by normalizing frequency of one harmonic of a plurality of slit harmonics generated by fluctuation of magnetoresistance in a rotation direction in the rotor core with the frequency of the modulated wave.

5. The motor driver according to claim 4, wherein
the tertiary order is any one of an order corresponding to frequency of a fundamental wave among a plurality of slit harmonics and an order corresponding to a frequency twice the fundamental wave among a plurality of slit harmonics.

6. The motor driver according to claim 3, wherein
the AC motor is a reluctance motor including a rotor core, the rotor core:
has a cylindrical shape;
is disposed on an inner surface side of the stator core; and
is equipped with a plurality of slits each consisting of an arc-shaped opening that is convex toward a cylinder center for each magnetic pole as viewed in a central axis direction of a cylinder and has an apex positioned on a q-axis, and
the gate signal generator is adapted to generate the gate signal such that the primary order matches the tertiary order,
where the tertiary order is a numerical value obtained by normalizing frequency of one harmonic of a plurality of slit harmonics generated by fluctuation of magnetoresistance in a rotation direction in the rotor core with the frequency of the modulated wave.

7. The motor driver according to claim 6, wherein
the tertiary order is any one of an order corresponding to frequency of a fundamental wave among a plurality of slit harmonics and an order corresponding to a
